(19) United States
(12) Patent Application Publication
(10) Pub. No.: US 2024/0142961 A1
(43) Pub. Date: May 2, 2024

(54) METHOD AND SYSTEM OF ESTIMATING GREENHOUSE GAS EMISSION AND NON-TRANSITORY COMPUTER-READABLE MEDIUM

(71) Applicant: INSTITUTE FOR INFORMATION INDUSTRY, Taipei City (TW)

(72) Inventors: Tsung-Hsi LIN, Taipei City (TW); Yun Sheng LI, Taipei City (TW); Yu Ling LEE, Taipei City (TW); Hsiao Pin LIN, Taipei City (TW); Chia Hou CHEN, Taipei City (TW)

(73) Assignee: INSTITUTE FOR INFORMATION INDUSTRY, Taipei City (TW)

(21) Appl. No.: 17/975,529

(22) Filed: Oct. 27, 2022

(51) Int. Cl. G05B 19/418; H02J 3/00

(52) U.S. Cl. CPC G05B 19/4188; G05B 19/4183; H02J 3/003

(57) ABSTRACT

A method of estimating greenhouse gas emission, performed by a processing device, includes: obtaining at least one time period of a number of working stations for a target manufacturing process of a product; obtaining a number of first power consumption data of the target manufacturing process, wherein the first power consumption data correspond to the working stations respectively; calculating a number of second power consumption data based on the at least one time period and the first power consumption data; searching for a number of target coefficients corresponding to the plurality of working stations respectively in coefficient database based on the target manufacturing process; and calculating greenhouse gas emission data of the target manufacturing process based on the second power consumption data and the target coefficients.

### BACKGROUND

### 1. Technical Field

This disclosure relates to a method and system of estimating greenhouse gas emission and a non-transitory computer-readable medium.

### 2. Related Art

With the development of international trend of reducing carbon emissions, the requirements for carbon emission data for manufacturers are also gradually increasing. For a small number of diversified product, calculating carbon emission manually is time-consuming. Even if the entire production line is equipped with sensors to measure the carbon emission data, continuous and intensive monitoring of data is still required.

Generally, the calculation of carbon emissions requires a large amount of data, such as data related to material type and amount of material, and data related to combustion such as the amount of fuel. When calculating carbon emission, a computer would need to access many databases to obtain said data, and perform huge amount of computation on the data to finally obtain carbon emission data.

### SUMMARY

Accordingly, this disclosure provides a method and system of estimating greenhouse gas emission and a non-transitory computer-readable medium.

According to one or more embodiments of this disclosure, a method of estimating greenhouse gas emission, performed by a processing device, includes: obtaining at least one time period of a number of working stations for a target manufacturing process of a product; obtaining a number of first power consumption data of the target manufacturing process of the product, wherein the first power consumption data correspond to the working stations respectively; calculating a number of second power consumption data based on the at least one time period of the working stations and the first power consumption data; searching for a number of target coefficients corresponding to the working stations respectively in coefficient database based on the target manufacturing process of the product; and calculating greenhouse gas emission data of the target manufacturing process of the product based on the second power consumption data and the target coefficients.

According to one or more embodiments of this disclosure, a system of estimating greenhouse gas emission includes: a coefficient database storing a number of target coefficients corresponding to a number of working stations for a target manufacturing process of a product respectively; and a processing device connected to the coefficient database, and configured to perform: obtaining at least one time period of the working stations; obtaining a number of first power consumption data of the target manufacturing process of the product, wherein the first power consumption data correspond to the working stations respectively; calculating a number of second power consumption data based on the at least one time period of the working stations and the first power consumption data; searching for a number of target coefficients corresponding to the working stations respectively in the coefficient database based on the target manufacturing process of the product; and calculating greenhouse gas emission data of the target manufacturing process of the product based on the second power consumption data and the target coefficients.

According to one or more embodiments of this disclosure, a non-transitory computer-readable medium stores instructions that, when executed by a processing device, cause the processing device to perform operations including: obtaining at least one time period of a number of working stations for a target manufacturing process of a product; obtaining a number of first power consumption data of the target manufacturing process of the product, wherein the first power consumption data correspond to the working stations respectively; calculating a number of second power consumption data based on the at least one time period of the working stations and the first power consumption data; searching for a number of target coefficients correspond to the working stations respectively in coefficient database based on the target manufacturing process of the product; and calculating greenhouse gas emission data of the target manufacturing process of the product based on the second power consumption data and the target coefficients.

In view of the above description, the method and system of estimating greenhouse gas emission and non-transitory computer-readable medium according to one or more embodiments of the present disclosure may generate greenhouse gas emission data of a target manufacturing process of a product merely using at least one time period of the working stations for the target manufacturing process and the power consumption data of the working stations. Therefore, compared to the conventional method of calculating greenhouse gas emission data, the method and system of estimating greenhouse gas emission and non-transitory computer-readable medium according to one or more embodiments of the present disclosure may have less computational load and take less time to estimate greenhouse gas emission.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a system of estimating greenhouse gas emission according to an embodiment of the present disclosure;

FIG. 2 is a flowchart illustrating a method of estimating greenhouse gas emission according to an embodiment of the present disclosure; and

FIG. 3 is a flowchart illustrating a procedure for calculating second power consumption data in a method of estimating greenhouse gas emission according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

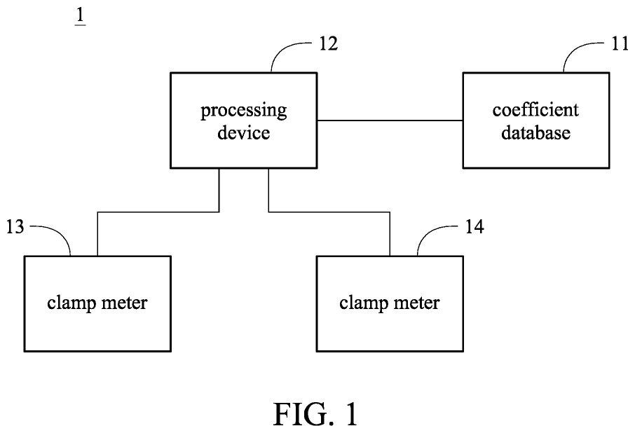

Please refer to FIG. 1 which is a block diagram illustrating a system of estimating greenhouse gas emission according to an embodiment of the present disclosure. The system of estimating greenhouse gas emission 1 includes a coefficient database 11, a processing device 12, coefficient database 11 and a number of clamp meters 13 and 14. It should be noted that FIG. 1 merely exemplarily shows two clamp meters 13 and 14, and is not intended to limit the number of clamp meters.

The coefficient database 11 may be implemented as a non-volatile memory, such as a flash memory, a hard drive (HDD), a solid state drive (SSD), a dynamic random-access memory (DRAM) or a static random-access memory (SRAM). The processing device 12 may include, but not limited to, a single processor and integration of multiple processors, such as central processing unit (CPU), graphics processing unit (GPU), etc. The processing device 12 and the coefficient database 11 may be electrically connected to each other as part of a personal computer or a server. Alternatively, the processing device 12 may be connected in communication with the coefficient database 11 via a communication network, such as a local area network (LAN), a Wi-Fi network, a wide area network (WAN), the Internet, etc. and which may be wired or wireless. The clamp meters 13 and 14 may be electrically connected to or in communication connection with the processing device 12 via a communication network, such as Bluetooth.

The coefficient database 11 may store a number of preset coefficient groups of a number of products. For example, the products may be copper foil, angle valve etc. Each preset coefficient group includes a number of coefficients corresponding to a number of work stations of a target manufacturing process of the product, wherein the target manufacturing process indicates a process with higher power consumption among all manufacturing processes. The data stored in the coefficient database 11 may further include a training set of at least one of the products. For each product, the processing device 12 may train an artificial neural network (ANN) model using the training set of the product, wherein the training set may include a number of training data each include power consumption data corresponding to the working stations, one or more time periods corresponding to the working stations, the value of greenhouse gas emission, etc. After training, power consumption data and one or more time periods of the product to be evaluated may be inputted into the trained ANN model to obtain the estimated greenhouse gas emission value. The trained ANN model may be used for adjusting the preset coefficient group of the product. Alternatively, the trained ANN model is a form of the preset coefficient group.

The processing device 12 is configured to select coefficients from the preset coefficient in the coefficient database 11 based on a target product whose greenhouse gas emission data is to be estimated and configured to obtain at least one time period corresponding to the target product, and estimate greenhouse gas emission of a target manufacturing process of the product based on power consumption of the working stations of the target manufacturing process as well as the selected coefficients.

The power consumption of the working stations of the target manufacturing process of the product may be obtained through the clamp meters 13 and 14. More specifically, the clamp meter 13 may be configured to measure an electric sensing value of a working station in the target manufacturing process, and the clamp meter 14 may be used to measure an electric sensing value of another working station in the target manufacturing process. The electric sensing values may be current values of a plurality of working stations in the target manufacturing process in a time period. That is, one working station may be equipped with one clamp meter. Alternatively, one working station may include a number of machines each of which equipped with one clamp meter. The processing device 11 may use the electric sensing values measured by the clamp meters 13 and 14 as the power consumption data of the working stations of the target manufacturing process of the product. Alternatively, the processing device 11 may perform data processing on the electric sensing values to generate the power consumption data. It should be noted that the clamp meters 13 and 14 are optionally included in the system of the present disclosure. That is, in some embodiments, the clamp meters 13 and 14 may be considered as devices external to the system. Moreover, the clamp meters 13 and 14 may be replaced with other devices having the function of power consumption measurement.

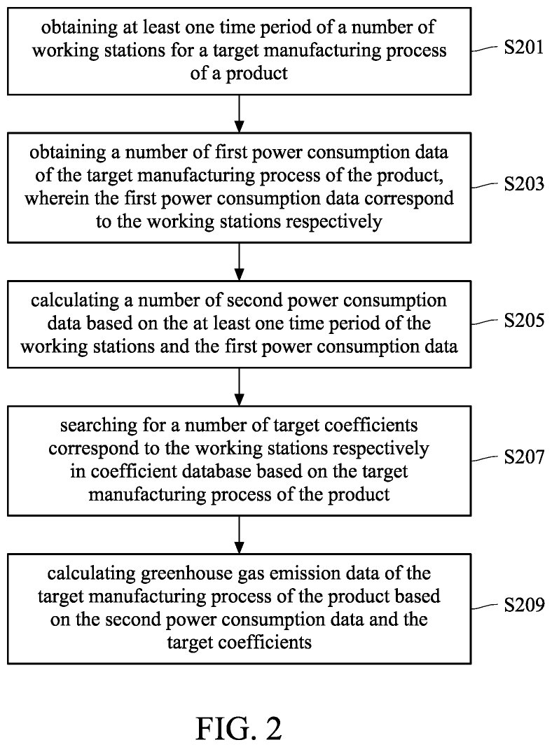

Please refer to FIG. 1 and FIG. 2, wherein FIG. 2 is a flowchart illustrating a method of estimating greenhouse gas emission according to an embodiment of the present disclosure. As shown in FIG. 2, the method of estimating greenhouse gas emission, performed by the processing device 12, includes: S201: obtaining at least one time period of a number of working stations for a target manufacturing process of a product; S203: obtaining a number of first power consumption data of the target manufacturing process of the product, wherein the first power consumption data correspond to the working stations respectively; S205: calculating a number of second power consumption data based on the at least one time period of the working stations and the first power consumption data; S207: searching for a number of target coefficients correspond to the working stations respectively in coefficient database based on the target manufacturing process of the product; and S209: calculating greenhouse gas emission data of the target manufacturing process of the product based on the second power consumption data and the target coefficients.

In step S201, for a target manufacturing process of a product, the processing device 12 obtains at least one time period of a number of working stations. Specifically, the at least one time period may be obtained from a manufacturing execution system (MES). The at least one time period may indicate a time period from a starting time point of manufacturing the product and an ending time point of manufacturing the product. In other words, the at least one time period may indicate a time period from the product entering the first one of the working stations to the product leaving the last one of the working stations.

In step S203, the processing device 12 obtains a number of first power consumption data of the target manufacturing process. Specifically, the processing device 12 may obtain the first power consumption data from the clamp meters 13 and 14 shown in FIG. 1. Each one of the first power consumption data corresponds to one of the working stations, and each one of the first power consumption data is the raw power consumption data of the corresponding working station. That is, one first power consumption data indicates raw power consumption data of one working station. The first power consumption data may be electricity consumption.

In step S205, the processing device 12 calculates a number of second power consumption data based on the at least one time period and the first power consumption data. Specifically, for each working station, the processing device 12 calculates total power consumption over the span of time of the product entering and leaving a working station, and uses the calculated total power consumption as the second power consumption data of this working station.

In step S207, as described above, the processing device 12 searches for a number of target coefficients from the coefficient database 11 based on the target manufacturing process of the product. One target coefficient corresponds to one working station of the target manufacturing process. Specifically, the processing device 12 searches for the target coefficients of the working stations that participate in manufacturing the product during the target manufacturing process.

In step S209, the processing device 12 calculates greenhouse gas emission data of the target manufacturing process of the product based on the second power consumption data and the target coefficients. Specifically, the processing device 12 multiplies each of the second power consumption data with the corresponding target coefficient, and uses a sum of the products (the multiplication result) as the greenhouse gas emission data of the target manufacturing process of the product.

More specifically, if the target manufacturing process of a product is mainly involved in three work stations, the coefficient database 11 may contain three coefficients corresponding to the three work stations, and the processing device 12 may calculate the greenhouse gas emission data of the target manufacturing process of the product using the following equation:

greenhouse gas emission data=Σ(aX,bY,cZ)

wherein a represents the target coefficient of the first work station, b represents the target coefficient of the second work station, c represents the target coefficient of the third work stations, X represents the second power consumption data of the first working station, Y represents the second power consumption data of the second working station, and Z represents the second power consumption data of the third working station.

Take copper foil as the product for example, the target manufacturing process of a copper foil may be approximately divided into three work stations, which are bare copper foil manufacture (first work station), surface treatment (second work station) and back-end stage (third work station) including checking, packaging, storage and transportation, etc. The target coefficients correspond to these work stations may each be 0.2635. It should be noted that, the values of the target coefficients mentioned above is only an example, and different target manufacturing process may have different target coefficients.

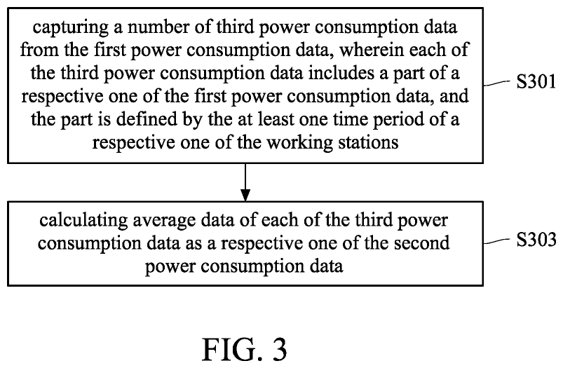

Please refer to FIG. 1 and FIG. 3, wherein FIG. 3 is a flowchart illustrating a method of estimating greenhouse gas emission according to another embodiment of the present disclosure. In this embodiment, the at least one time period may indicate a number of time periods corresponding to the working stations respectively, where each time period indicates a period from the product entering one working station to the product leaving one working station.

Step S301 and step S303 shown in FIG. 3 may be sub-steps of step S205 in FIG. 2. As shown in FIG. 3, step S205 in FIG. 2 may include: step S301: capturing a number of third power consumption data from the number of first power consumption data, wherein each of the number of third power consumption data includes a part of a respective one of the number of first power consumption data, and the part is defined by the at least one time period of a respective one of the number of working stations; and S303: calculating average data of each of the number of third power consumption data as a respective one of the number of second power consumption data.

In step S301, the processing device 12 captures a number of third power consumption data from the number of first power data based on the number of time periods, wherein each of the number of third power consumption data includes a part defined by one time period of a respective first power consumption data. One third power consumption data indicates amount of electricity used during the respective time period.

Specifically, as described above, the processing device 12 may be connected to the clamp meters 13 and 14, which are used to measure the electricity consumption of respective one of the working stations. In a situation where the clamp meters 13 and 14 operate continuously and regardless of whether the respective working station is processing the product or not, the measured electricity consumption (first power consumption data) is a series of data. Therefore, in step S301, the processing device 12 captures a section of the first power consumption data of the time period as the third power consumption data, wherein the working station is processing the product during the time period. That is, one third power consumption data is a part of one first power consumption data that is within one time period of one working station, wherein the part of one first power consumption data includes the starting time point and ending time point of said one time period.

In step S303, the processing device 12 calculates average data of each third power consumption data as a respective one of the number of second power consumption data. That is, for each time period, the processing device 12 calculates average data of amount of electricity used (third power consumption) during the respective time period, and uses the average data as the respective one of the second power consumption data. In other words, one second power consumption data is the average of amount of electricity used during the treatment/processing of the product at the respective working station.

For example, please refer to the following table 1, each work station corresponds to one time period, wherein the time period shown in table 1 is an average of time required to finish processing the product at the work station. Therefore, the processing device 12 may calculate average data of amount of electricity used during each time period, and the calculated average data may be used as one second power consumption data.

TABLE 1

| | average time (per 10 ton) | |
|---|---|---|
| First work station | 11.2 | hrs |
| Second work station | 3.2 | hrs |
| Third work station | 1.6 | hrs |

Please refer to the following three tables, which shows the greenhouse gas emission data of the target manufacturing process of a copper foil from a standard database, the data for the calculation of greenhouse gas emission and the calculated results of the target manufacturing process of a copper foil using the method and system of estimating greenhouse gas emission as mentioned in the above embodiments.

TABLE 2

| Copper foil | A | B | C | D | E | F | average | unit |
|---|---|---|---|---|---|---|---|---|
| Greenhouse | 8.72 | 10.01 | 10.61 | 13.73 | 13.89 | 15.49 | 12.08 | kgCO₂e/kg |
| gas emission | | | | | | | | |
| data | | | | | | | | |

Table 2 shows the actual greenhouse gas emission data of six manufacturers (manufacturer A to manufacturer F, the data could be indexed from “Carbon Footprint Information Platform” website). As shown in table 2, the average greenhouse gas emission data actually measured of these six manufacturers is 12.08 (kgCO₂e/kg).

TABLE 3

| Copper foil | A | B | C | D | E | F |
|---|---|---|---|---|---|---|
| First work | 24.549 | 29.645 | 26.894 | 34.468 | 35.231 | 41.734 |
| station | | | | | | |
| Second | 7.014 | 8.47 | 7.684 | 9.848 | 10.066 | 11.924 |
| work | | | | | | |
| station | | | | | | |
| Third work | 3.507 | 4.235 | 3.842 | 4.924 | 5.033 | 5.962 |
| station | | | | | | |

Table 3 shows the second power consumption data of the six manufacturers during the three work stations of manufacturing copper foil, wherein the unit of each second power consumption data in table 3 is ampere (A), and the three work stations are bare copper foil manufacture (first work station), surface treatment (second work station) and back-end stage (third work station) including checking, packaging, storage and transportation, etc. as mentioned above.

TABLE 4

| Copper foil | A | B | C | D | E | F |
|---|---|---|---|---|---|---|
| First work | 6.468661 | 7.8115 | 7.0866 | 9.0823 | 9.2834 | 10.997 |
| station | | | | | | |
| Second work | 1.848 | 2.2318 | 2.0247 | 2.5949 | 2.6524 | 3.142 |
| station | | | | | | |
| Third work | 0.924 | 1.1159 | 1.0124 | 1.2975 | 1.3262 | 1.571 |
| station | | | | | | |
| Σ(greenhouse | 9.084661 | 10.427 | 9.7026 | 11.698 | 11.899 | 13.613 |
| gas emission | | | | | | |
| data) | | | | | | |
| Error rate | 0.041818 | 0.041704 | −0.08553 | −0.14797 | −0.14331 | −0.12118 |

Table 5 shows greenhouse gas emission data of each work station, as well as the error rates comparing to the total greenhouse gas emission data of table 2 respectively. The greenhouse gas emission data of each work station is calculated using the equation shown above, and the error value is the difference between the greenhouse gas emission data shown in table 2 and the sum of greenhouse gas emission data shown in table 5. The average of the absolute values of the error rates in table 4 is 0.09692, which means the accuracy rate of this embodiments is more than 90%. The unit of the values shown in table 5 is kgCO₂e/kg.

As seen from table 2, table 3 and table 4, the greenhouse gas emission data estimated using method and system of estimating greenhouse gas emission of the present disclosure only has a slight different from the greenhouse gas emission data actually measured.

In some embodiments of the present disclosure, the operations of the method of estimating greenhouse gas emission as described in the above embodiments may be implemented using computer-readable instructions that are stored on a non-transitory computer-readable medium stores instructions, such that when the instructions are executed by one or more processor (e.g. the processing device 12 in FIG. 1), the instructions cause to the one or more processors perform the operations as described in the above embodiments.

In view of the above description, the method and system of estimating greenhouse gas emission and non-transitory computer-readable medium according to one or more embodiments of the present disclosure may generate greenhouse gas emission data of a target manufacturing process of a product merely using at least one time period of the working stations for the target manufacturing process and the power consumption data of the working stations. Therefore, compared to the conventional method of calculating greenhouse gas emission data, the method and system of estimating greenhouse gas emission and non-transitory computer-readable medium according to one or more embodiments of the present disclosure may have less computational load and take less time to estimate greenhouse gas emission. Moreover, the method and system of estimating greenhouse gas emission and non-transitory computer-readable medium according to one or more embodiments of the present disclosure may generate greenhouse gas emission data with almost the same accuracy as a conventional method using less data than the conventional method.

What is claimed is:

1. A method of estimating greenhouse gas emission, performed by a processing device, comprising:
obtaining at least one time period of a plurality of working stations for a target manufacturing process of a product;
obtaining a plurality of first power consumption data of the target manufacturing process of the product, wherein the plurality of first power consumption data correspond to the plurality of working stations respectively;
calculating a plurality of second power consumption data based on the at least one time period of the plurality of working stations and the plurality of first power consumption data;
searching for a plurality of target coefficients corresponding to the plurality of working stations respectively in coefficient database based on the target manufacturing process of the product; and
calculating greenhouse gas emission data of the target manufacturing process of the product based on the plurality of second power consumption data and the plurality of target coefficients.

2. The method of estimating greenhouse gas emission according to claim 1, wherein calculating the plurality of second power consumption data comprises:
capturing a plurality of third power consumption data from the plurality of first power consumption data, wherein each of the plurality of third power consumption data comprises a part of a respective one of the plurality of first power consumption data, and the part is defined by the at least one time period of a respective one of the plurality of working stations; and
calculating average data of each of the plurality of third power consumption data as a respective one of the plurality of second power consumption data.

3. The method of estimating greenhouse gas emission according to claim 1, wherein obtaining the plurality of first power consumption data comprises:
obtaining electric sensing values of the plurality of working stations through a plurality of clamp meters as the plurality of first power consumption data.

4. The method of estimating greenhouse gas emission according to claim 1, wherein the at least one time period is obtained from a manufacturing execution system.

5. The method of estimating greenhouse gas emission according to claim 1, wherein the coefficient database comprises a plurality of preset coefficients of a plurality of products.

6. The method of estimating greenhouse gas emission according to claim 1, wherein data of the coefficient database comprises a training set of the product.

7. A system of estimating greenhouse gas emission, comprising:
a coefficient database storing a plurality of target coefficients corresponding to a plurality of working stations for a target manufacturing process of a product respectively; and
a processing device connected to the coefficient database, and configured to perform:
obtaining at least one time period of the plurality of working stations;
obtaining a plurality of first power consumption data of the target manufacturing process of the product, wherein the plurality of first power consumption data correspond to the plurality of working stations respectively;
calculating a plurality of second power consumption data based on the at least one time period of the plurality of working stations and the plurality of first power consumption data;
searching for the plurality of target coefficients corresponding to the plurality of working stations respectively in the coefficient database based on the target manufacturing process of the product; and
calculating greenhouse gas emission data of the target manufacturing process of the product based on the plurality of second power consumption data and the plurality of target coefficients.

8. The system of estimating greenhouse gas emission according to claim 7, wherein for calculating the plurality of second power consumption, the processing device captures a plurality of third power consumption data from the plurality of first power consumption data, and calculates average data of each of the plurality of third power consumption data as a respective one of the plurality of second power consumption data,
wherein each of the plurality of third power consumption data comprises a part of a respective one of the plurality of first power consumption data, and the part is defined by the at least one time period of a respective one of the plurality of working stations.

9. The system of estimating greenhouse gas emission according to claim 7, further comprising:
a plurality of clamp meters connected to the processing device and configured to measure a plurality of electric sensing values of the plurality of working stations,
wherein the processing device obtains the plurality of electric sensing values from the plurality of clamp meters as the plurality of first power consumption data.

10. The system of estimating greenhouse gas emission according to claim 7, wherein the at least one time period is obtained from a manufacturing execution system.

11. The system of estimating greenhouse gas emission according to claim 7, wherein the coefficient database stores a plurality of preset coefficients of a plurality of products.

12. The system of estimating greenhouse gas emission according to claim 7, wherein data of the coefficient database comprises a training set of the product.

13. A non-transitory computer-readable medium storing instructions that, when executed by a processing device, cause the processing device to perform operations comprising:
obtaining at least one time period of a plurality of working stations for a target manufacturing process of a product;
obtaining a plurality of first power consumption data of the target manufacturing process of the product, wherein the plurality of first power consumption data correspond to the plurality of working stations respectively;
calculating a plurality of second power consumption data based on the at least one time period of the plurality of working stations and the plurality of first power consumption data;
searching for a plurality of target coefficients corresponding to the plurality of working stations respectively in coefficient database based on the target manufacturing process of the product; and
calculating greenhouse gas emission data of the target manufacturing process of the product based on the plurality of second power consumption data and the plurality of target coefficients.

14. The non-transitory computer-readable medium according to claim 13, wherein calculating the plurality of second power consumption data comprises:
capturing a plurality of third power consumption data from the plurality of first power consumption data, wherein each of the plurality of third power consumption data comprises a part of a respective one of the plurality of first power consumption data, and the part is defined by the at least one time period of a respective one of the plurality of working stations;
and calculating average data of each of the plurality of third power consumption data as a respective one of the plurality of second power consumption data.

15. The non-transitory computer-readable medium according to claim 13, wherein obtaining the plurality of first power consumption data comprises:
obtaining electric sensing values of the plurality of working stations from a plurality of clamp meters as the plurality of first power consumption data.

16. The non-transitory computer-readable medium according to claim 13, wherein the at least one time period is obtained from a manufacturing execution system.
